(19) United States
(12) Patent Application Publication
(10) Pub. No.: US 2012/0225371 A1
(43) Pub. Date: Sep. 6, 2012

(54) IONOMER FOR ALKALINE FUEL CELL

(75) Inventors: Yu Seung Kim, Los Alamos, NM (US); Dae Sik Kim, Yuseung-ku (KP)

(73) Assignee: LOS ALAMOS NATIONAL SECURITY, LLC, Los Alamos, NM (US)

(21) Appl. No.: 13/409,505

(22) Filed: Mar. 1, 2012

Related U.S. Application Data
(60) Provisional application No. 61/448,834, filed on Mar. 3, 2011.

(51) Int. Cl. H01M 4/62; H01M 4/92; H01M 4/90; C08J 5/22; H01M 8/10

(52) U.S. Cl. 429/484; 521/27; 429/530

(57) ABSTRACT

An ionomer may be used as a binder for a catalyst to prepare an anode for a solid alkaline fuel cell. The ionomer is a reaction product of a guanidine and a perfluorosulfonic acid polymer.

### RELATED APPLICATIONS

This application claims the benefit of U.S. Provisional Application No. 61/448,834 entitled “Ionomer for Alkaline Fuel Cell,” filed Mar. 3, 2011, hereby incorporated by reference.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to alkaline fuel cells (“AFCs”), and more particularly to ionomers that may be used as catalyst binders for anodes in AFCs.

### BACKGROUND OF THE INVENTION

Fuel cells convert the chemical energy of fuel into electrical energy. Polymer electrolyte fuel cells (“PEFCs”) and alkaline fuel cells (“AFCs”) are well known examples of fuel cells. PEFCs have a relatively simple cell design and use a liquid fuel (e.g. methanol, ethanol, ethylene glycol, glycerol, dimethyl ether, hydrazine, and the like) that can be easily delivered to the cell and have a high energy density. PEFCs require expensive precious metals (e.g. platinum) as electrocatalysts, and operate under acidic conditions, for which the oxidation of the liquid fuel is slow. By contrast, alkaline fuel cells (“AFCs”) may use relatively inexpensive catalysts made from non-precious metals that tend to have a high activity under alkaline conditions.

A schematic diagram of a solution-based, H₂/air AFC is shown in FIG. 1. The half reactions at the anode and cathode are:

3H₂+6OH⁻→6H₂O+6e⁻(anode)

3/2 O₂+3H₂O+6e⁻→6OH⁻(cathode)

Hydroxide ions (OH⁻) are generated at the cathode and are transported through an anion exchange membrane to the anode where they react with fuel to generate water and electrons.

A solid alkaline fuel cell (“SAFC”) is a type of AFC that does not have a liquid electrolyte. There are advantages to using a solid electrolyte instead of a liquid electrolyte (e.g. smaller volume, less corrosive electrolyte).

The performance and durability of SAFCs currently is inferior to that for PEFCs. This difference in performance is due, at least in part, to the polymeric materials used in the membranes and electrodes. PEFCs use cation exchange polymer membranes while SAFCs use anion exchange membranes. Anion exchange polymer membranes currently used with SAFCs tend to exhibit lower ion conductivity, have poorer mechanical properties, and degrade faster under fuel cell operating conditions than cation exchange polymer membranes used with PEFCs. There are also problems associated with the electrodes. Electrode reactions for SAFCs occur at a three-phase (liquid/gas/solid) interface that must be adequately formed to prevent the electrode reaction rates from being controlled by gas diffusion. A significant loss in fuel cell performance is due to flooding (i.e. slow removal of accumulated water) which limits gas diffusion. In SAFCs that are H₂/air fuel cells, flooding occurs at the anode (i.e. the hydrogen electrode).

Past attempts at resolving flooding problems in electrochemical cells have sometimes involved incorporating a hydrophobic, polytetrafluoroethylene copolymer with a catalyst layer. This has resulted in a decrease in ionic conductivity in the catalyst layer. Fluorinated binders have generally not been utilized with SAFCs in the past because fluorinated polymers are not stable under alkaline conditions. The fluorine present in these materials reduces the electron density of the cationic functional groups of anion exchange polymers to such an extent that relatively fast degradation of the polymer occurs in most cases.

There have been attempts at improving the stability of fluorinated polymers in alkaline media by incorporating electron donating spacers between cation functional group and fluorinated moiety. For example, perfluorinated anion exchange polymer electrolytes having electron donating spacer between the fluorinated side chain and cation functional group were prepared for the electrode materials. However, the synthesis of these polymer electrolytes requires complex multi-step polymerization chemistry, and the solubility of the resultant materials is poor, which limits the electrode processing capabilities.

Miyazaki has reported preparation of ionomers of aminated perfluorosulfonic acid polymers known in the art as NAFION® polymers for improving the triple phase boundary regions in anion exchange membrane fuel cells (see: Miyazaki et al., “Aminated Perfluorosulfonic Acid Ionomers to Improve the Triple Phase Boundary Region in Anion-Exchange Membrane Fuel Cells,” Journal of the Electrochemical Society, 2010, vol. 157, number 11, pp. A1153-A1157, incorporated by reference).

It is desirable to improve the performance of SAFCs that have been limited by flooding at the anode.

### SUMMARY OF THE INVENTION

In accordance with the purposes of the present invention, as embodied and broadly described herein, an aspect of the present invention includes a polymeric product of the reaction of a guanidine with a polymer comprising a perfluorosulfonic acid. The guanidine has the formula

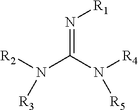

wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CH—COOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group, halide, or halide-substituted methyl group.

The invention is also concerned with an anode for an alkaline fuel cell. The anode includes a catalyst and a binder. The binder is a polymeric reaction product of the reaction of a guanidine with apolymer comprising a perfluorosulfonic acid. The guanidine has the formula

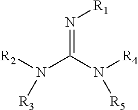

wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group, halide, or halide-substituted methyl group. Anodes prepared with these materials are expected to play a role in minimizing flooding at the anode.

The invention is also concerned with an alkaline fuel cell comprising an anode that includes a catalyst and a binder, wherein the binder is a polymeric reaction product of the reaction of a perfluorosulfonic acid and a guanidine having the formula

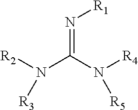

wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group, halide, or halide-substituted methyl group. These materials are expected to play a role in minimizing flooding at the anode of these fuel cells during operation.

The invention is also concerned with an alkaline fuel cell comprising an anode that is a hydrogen electrode, an anion conducting membrane, and a cathode that is an oxygen electrode. The anode is a composite including an electro-catalyst (50 to 90 weight percent) for hydrogen oxidation and a binder (10 to 50 weight percent). The binder is a polymeric reaction product of a reaction between a perfluorosulfonic acid polymer composition and an amine such as a guanidine having the formula

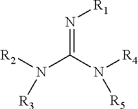

wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)—CH—(NH₂)—COOH, where n=1-6, —(CH₂)ₙ—CH═CH where n=1-6, —(CH₂), —CH—CN where n=1-6, an aromatic group, halide, or halide-substituted methyl group. These materials are expected to play a role in minimizing flooding at the anode of these fuel cells during operation.

The invention is also a polymeric ionomer comprising a guanidinium perfluorosulfonate polymer.

### BRIEF DESCRIPTION OF THE DRAWINGS

The accompanying drawings are incorporated in and form a part of the specification. In the drawings:

FIG. 1 shows a schematic diagram of a solid-based alkaline fuel cell.

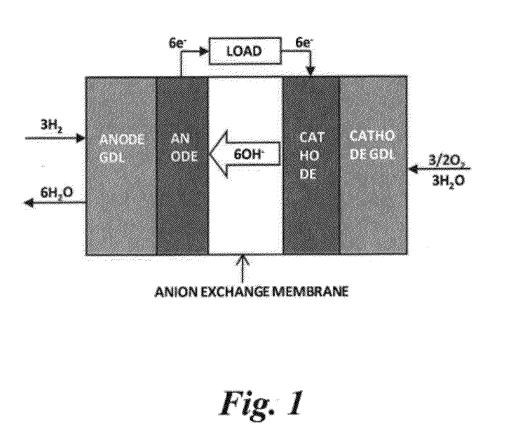

### DETAILED DESCRIPTION

This invention is concerned with ionomers that may be used with solid alkaline fuel cells (SAFCs). These ionomers are reaction products of a guanidine with a perfluorosulfonic acid polymer. The perfluorosulfonic acid polymer is a sulfonic acid containing polymer that is derived from copolymerization of a perfluorinated vinyl ether monomer with tetrafluoroethylene monomer resulting in the chemical structure

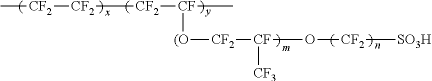

wherein x=1-15, y=1, m=0 or 1, and n=1-5. When m=1 and n=2, this perfluorosulfonic acid polymer is a polymer known in the art as a NAFION® polymer.
The guanidine has the formula

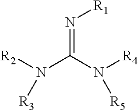

wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)—CH—CN where n=1-6, an aromatic group, halide, or halide-substituted methyl group. The aromatic group may be phenyl, benzyl, phenoxy, methylbenzyl, nitrogen-substituted benzyl, or nitrogen-substituted phenyl.

The invention is also concerned with SAFCs that are hydrogen/air fuel cells, or hydrogen/oxygen fuel cells. The anode of a H₂/air fuel cell sometimes referred to as the hydrogen electrodes. The cathode is sometimes referred to as the oxygen electrode. In an embodiment, an anode of a SAFC is a composite a catalyst (e.g. carbon, transition metal(s), oxides of transition metal(s), and the like) and an ionomer binder that is a polymeric reaction product of a reaction between a perfluorosulfonic acid polymer and an amine. In an embodiment, the perfluorosulfonic acid material is a NAFION® polymer and the amine is a guanidine. The polymeric reaction product is a complex of the perfluorosulfonic acid polymer such as NAFION® and a guanidinium cation of the formula:

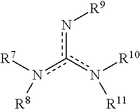

wherein R₇, R₈, R₉, R₁₀ or R₁₁ each independently are —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group such as a phenyl, benzyl, phenoxy, methylbenzyl, nitrogen-substituted benzyl or phenyl groups, a halide, or halide-substituted methyl group.

In another embodiment, the ionomer binder is a reaction product of a perfluorosulfonic acid polymer such as NAFION® with an amine selected from the following amines:

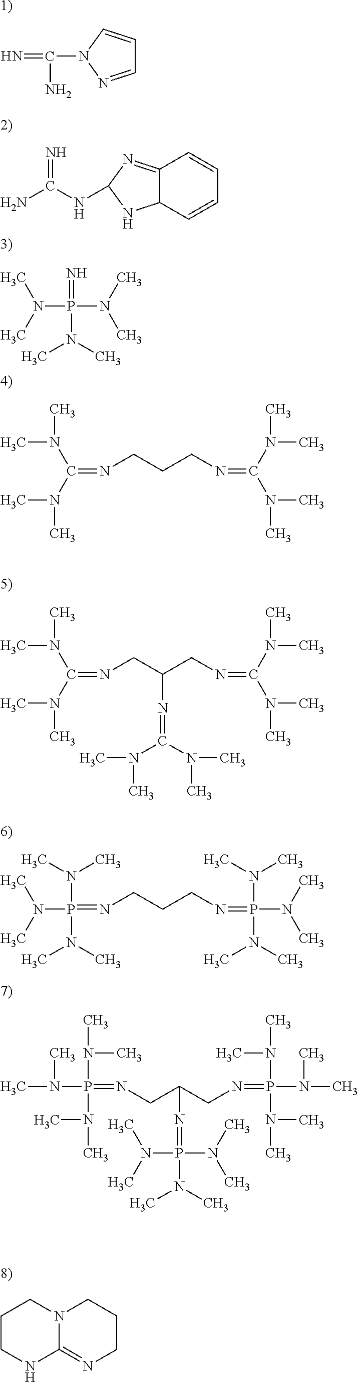

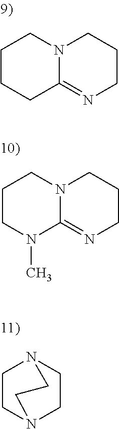

In another embodiment, the ionomer binder is a reaction product of a perfluorosulfonic acid polymer such as NAFION® and an amine selected from imidazole, benzimidazole, or a polymer containing an imidazole group or a benzimidazole group. Examples of these amines are

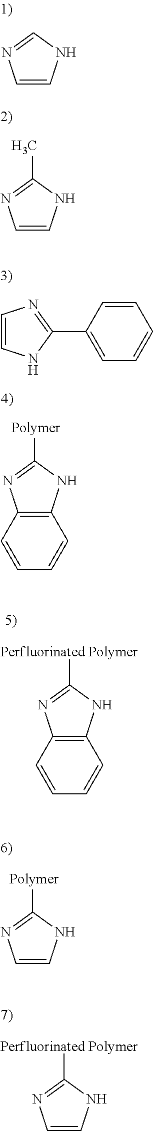

The structures 1, 2, and 3 above are small molecules containing imidazole. The structure 4 is has a polymeric backbone called “polymer” and pendant groups that are benzimidazole groups. The structure 5 has a polymeric backbone called “perfluorinated polymer” and pendant groups that are benzimidazole groups. Structure 6 is a polymer having a polymeric backbone called “polymer” and pendant groups that are imidazole groups. Structure 7 is a polymer having a polymer backbone called “perfluorinated polymer” and pendant groups that are imidazole groups. Perfluorinated polymer is a fluorocarbon derivative polymer with all hydrogen replaced by fluorine on the carbon chain.

When reaction products of this invention are prepared, the perfluorosulfonic acid polymer in its salt form, acid form or precursor may be used. In general, salt forms of perfluorosulfonic acid polymers form better dispersions than the corresponding acid form does in a liquid medium. Same examples of salt counter ions include lithium, sodium, potassium, and alkyl ammonium. Sulfonyl fluoride perfluorosulfonic acid polymer precursor also can be used. The acid form, salt form or precursor of perfluorosulfonic acid polymer may be dissolved in protic or aprotic solvent or dispersed in a dispersion medium. A suitable solvent should dissolve the perfluorosulfonic acid polymer. Some examples of solvents or dispersion media include water, ethanol, n-propanol, isopropanol, n-butanol, sec-butanol, isobutanol, tert-butanol, ethylene glycol, propylene glycol, 1,2-butanediol, 1,3-butanediol, 2,3-butanediol, 1,4-butanediol, 1,5-pentanediol, propane-1,2,3-triol, 1,2,4-butanetriol, dimethylformamide (DMF), dimethylacetamide (DMAc), N-methylpyrrolidone (NMP) or dimethylsulfoxide (DMSO) and combinations thereof.

In an embodiment, a perfluorosulfonic acid polymer was dissolved into a solvent and then a solution of a guanidine was added to the perfluorosulfonic acid polymer solution. In another embodiment, a perfluorosulfonic acid polymer was dispersed into a liquid and then a solution of a guanidine was added to the perfluorosulfonic acid polymer dispersion.

Another aspect of the present invention is concerned with a membrane electrode assembly (MEA) comprising aminated polymer and catalyst. The term “catalyst” means a catalyst that when incorporated into electrode facilitates an electrochemical reaction. These catalysts are also referred to as “electrocatalysts”. Examples of catalysts include a metal or metals selected from precious metals such as platinum, palladium, rhodium, ruthenium, iridium, osmium, gold, silver, or a non-precious metal such as nickel, cobalt, manganese, and the like, or an oxide of a non-precious metal, or a perovskite-type oxide, or an alloy or mixture comprising one or more of the aforementioned precious and/or non-precious metals preferably supported on a conductive substrate, such as carbon. Various forms of carbon such as particulate carbon, carbon nanotubes, and nanotube/perovskite composites can be used in the electrodes.

The catalyst may be applied in the form of a dispersion of the catalyst known as an ink. For example, in an embodiment, a perfluorosulfonic acid polymer such as NAFION® is immersed into guanidine solution in room temperature for 4 hours. After that, the polymer is removed from the solution and washed with pure water and dried in an oven at a temperature of 80° C. The product is a dried, aminated polymer membrane, which is dispersed in 2.5 weight percent DMF. A catalyst ink of platinum black in 2.5 weight percent DMF is painted onto both sides of the polymer membrane.

The catalyst may be applied to the aminated polymer using a method such as direct painting of catalyst ink on to membrane, decal transfer, spray painting, screen printing, roll coating, hot pressing, and the like. Concentrations of the polymer electrolytes in the liquid medium is not particularly limited, and may be properly determined depending on a combination of the solvent and said compounds, amounts used to the electrode catalyst, viscosity, permeability at applying it, etc., but it is preferably 0.1 to 20 mass %, particularly preferably 0.5 to 10 mass %, as a total mass % of both of the compounds in a liquid medium. Using these fabrication methods, highly stable and durable interface between membrane and electrode can be obtained.

Membrane electrode assemblies (“MEAs”) may be prepared from dispersions of ionomer, and by using previous MEA fabrication methods that were developed for proton exchange membrane fuel cells [M. Wilson, U.S. Pat. No. 5,998,057, Koschany et al. U.S. Pat. No. 5,998,057 and Kim et al. U.S. patent application Ser. No. 12/321,466 (2008), all incorporated by reference]. Other known methods such as direct painting of catalyst ink on to membrane, decal transfer, spray painting, screen printing, roll coating, hot pressing etc. can also be used. Using these fabrication methods, a highly stable and durable interface between membrane and electrode can be obtained without using cross-linking reaction which is known for the state of the art MEA fabrication for anion exchange membrane fuel cells [Matsuoka H. EP 1965456]. Examples 1, 2 and 3 explain the synthesis of ionomers and dispersion solution preparation.

### Example 1

Ionomer preparation: A perfluorosulfonic acid polymer (NAFION®) membrane was immersed in a solution of 1,1,3,3-tetramethylguanidine (TMG) for 2 hours. Then, the membrane was repeatedly soaked in pure water enough to remove excess amine.

### Example 2

Ionomer preparation: A perfluorosulfonic acid polymer (NAFION®) membrane was dissolved in a solution of NMP. The solution of 1,1,3,3-tetramethylguanidine (TMG) was added into polymer solution. Then, this polymer solution was cast on a glass plate and dried. The membrane was repeatedly soaked in pure water enough to remove excess amine.

### Example 3

Dispersion preparation: An embodiment ionomer is dissolved in a solution containing 2.5 wt percent NMP.

### Comparative Example 1

Comparative Example 1 describes a dispersion preparation using hydrocarbon polymer with quaternary ammonium groups. A poly(phenylene) polymer with pendant quaternary ammonium groups (provided by Sandia National Laboratory) was dissolved in a methanol solution containing 2.5 weight percent DMF (dimethylformamide).

### Example 4

Example 4 describes a membrane electrode assembly (MEA) preparation using an ionomer binder for anode and hydrocarbon polymer having quaternary ammonium groups for cathode. The poly(phenylene) polymer with pendant quaternary ammonium groups was provided by Sandia National Laboratory. To prepare the anode, 200 milligrams (“mg”) of polymer dispersion solution prepared from Example 1 is mixed with 45 mg Pt black in a small vial. The mixture is agitated with ultrasound to uniformly disperse the supported catalyst in the catalyst ink. The catalyst ink is painted on Decal surface and dried at 140° C.

To prepare the cathode, 200 mg of polymer dispersion solution prepared from Comparative Example 1 is mixed with 45 mg Pt black in a small vial. The mixture is agitated with ultrasound to uniformly disperse the supported catalyst in the catalyst ink. The catalyst ink is painting on Decal surface and dry at 140° C.

A catalyst layer transfer on the poly(phenylene)-based anion exchange polymer is performed using hot pressing (3 LB (“pounds of pressure”) for 4 minutes, 4LB for 4 minutes). The active area is 5 cm². The catalyst loading is 3 mg/cm². The MEA is immersed into 1M NaOH solution for 1 hour and washed with pure water, and is rinsed in boiling deionized water for 1 hour. The MEA is dried at 75° C. under vacuum.

### Comparative Example 2

Comparative Example 2 describes a membrane electrode assembly (MEA) preparation using a hydrocarbon polymer having quaternary ammonium groups for anode and cathode. To prepare the anode and cathode, 200 milligrams (mg) of polymer dispersion solution prepared from Comparative Example 1 is mixed with 45 mg Pt black in a small vial. The mixture is agitated with ultrasound to uniformly disperse the supported catalyst in the catalyst ink. The catalyst ink is painted on a Decal surface and dried at 140° C. A catalyst layer transfer on the membrane (Poly(phenylene)-based anion exchange polymer—Sandia National Lab.) may be performed using hot pressing (3 LB (“pounds of pressure”) for 4 minutes, 4LB for 4 minutes). The active area is 5 cm². The catalyst loading reached to 3 mg/cm². The MEA was immersed into 1M NaOH solution for 1 hr and washed with pure water, and rinse in boiling deionized water for 1 hr. The MEA is dried at 75° C. under vacuum.

### Example 5

Example 5 describes a membrane electrode assembly (MEA) preparation using an ionomer binder for the anode and hydrocarbon polymer having quaternary ammonium groups for the cathode. A highly fluorinated poly(arylene) copolymer with pendant quaternary ammonium groups may be used for an anion exchange membrane.

An anode may be prepared as follows: 200 mg of polymer dispersion solution prepared from Example 1 is mixed with 45 mg Pt black in a small vial. The mixture is agitated with ultrasound to uniformly disperse the supported catalyst in the catalyst ink. The catalyst ink is painted on a Decal surface and dried at 140° C.

A cathode may be prepared as follows: 200 mg of polymer dispersion solution prepared from Comparative Example 1 was mixed with 45 mg Pt black in a small vial. The mixture is agitated with ultrasound to uniformly disperse the supported catalyst in the catalyst ink. The catalyst ink is painted on a Decal surface and dried at 140° C.

A catalyst layer may be transferred onto the membrane of highly fluorinated Poly(arylene) copolymer with pendant quaternary ammonium groups using hot pressing (3 LB for 4 min, 4 LB for 4 min). The active area is 5 cm². The catalyst loading is 3 mg/cm². The MEA is immersed into 1M NaOH solution for 1 hr and washed with pure water, and is rinsed in boiling deionized water for 1 hr. The MEA is dried at 75° C. under vacuum.

### Comparative Example 3

Comparative Example 3 describes a membrane electrode assembly (MEA) preparation using a hydrocarbon polymer having quaternary ammonium groups for anode and cathode. The anode and cathode may be prepared as follows: 200 mg of polymer dispersion solution prepared from Comparative Example 1 is mixed with 45 mg Pt black in a small vial. The mixture is agitated with ultrasound to uniformly disperse the supported catalyst in the catalyst ink. The catalyst ink is painted on a Decal surface and dried at 140° C. The catalyst layer transfer on the membrane of highly fluorinated Poly(arylene) copolymer with pendant quaternary ammonium groups may be performed using hot pressing (3 LB for 4 min, 4 LB for 4 min). The active area is 5 cm². The catalyst loading is 3 mg/cm². The MEA is immersed into 1M NaOH solution for 1 hr and washed with pure water, and rinse in boiling deionized water for 1 hr. The MEA is dried at 75° C. under vacuum.

Although the present invention has been described with reference to specific details, it is not intended that such details should be regarded as limitations upon the scope of the invention, except as and to the extent that they are included in the accompanying claims.

What is claimed is:

1. A polymeric reaction product of a reaction of a guanidine with a perfluorosulfonic acid polymer.

2. The product of claim 1, wherein said guanidine has the formula 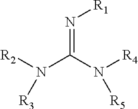
wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group, halide, or halide-substituted methyl group.

3. The product of claim 2, wherein the aromatic group is selected from phenyl, benzyl, phenoxy, methylbenzyl, nitrogen-substituted benzyl, or nitrogen-substituted phenyl.

4. An anode for an alkaline fuel cell, said anode comprising a catalyst dispersed on an ionomer prepared by aminating a perfluorosulfonic acid-containing polymer with a guanidine.

5. The anode of claim 4, wherein said guanidine has the formula 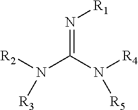
wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group, halide, or halide-substituted methyl group.

6. The anode of claim 4, wherein the catalyst comprises a precious metal.

7. The anode of claim 4, wherein the catalyst comprises a non-precious metal.

8. An alkaline fuel cell comprising:
a solid electrolyte,
an anode in the solid electrolyte, said anode being a hydrogen electrode;
a cathode in the solid electrolyte, said cathode being an oxygen electrode in electrical communication with the anode,
said anode comprising a catalyst and a binder, said binder comprising a reaction product of a guanidinium and a polymer having perfluorosulfonic acid groups.

9. The alkaline fuel cell of claim 8, wherein the guanidine has the formula 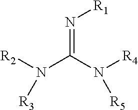
wherein R₁, R₂, R₃, R₄, and R₅ are each independently selected from —H, —CH₃, —NH₂, —NO, —CHₙCH₃ where n=1-6, HC(═O)—, CH₃C(═O)—, NH₂C(═O)—, —CHₙCOOH where n=1-6, —(CH₂)ₙ—C(NH₂)—COOH where n=1-6, —CH—(COOH)—CH₂—COOH, —CH₂—CH(O—CH₂CH₃)₂, —(C═S)—NH₂, —(C═NH)—N—(CH₂)ₙCH₃, where n=0-6, —NH—(C═S)—SH, —CH₂—(C═O)—O—C(CH₃)₃, —O—(CH₂)ₙ—CH—(NH₂)—COOH, where n=1-6, —(CH₂)ₙ—CH═CH where n=1-6, —(CH₂)ₙ—CH—CN where n=1-6, an aromatic group, halide, or halide-substituted methyl group.
